(19) United States
(12) Patent Application Publication
(10) Pub. No.: US 2014/0267820 A1
(43) Pub. Date: Sep. 18, 2014

(54) IMAGE PROCESSING APPARATUS AND METHOD

(71) Applicant: KABUSHIKI KAISHA TOSHIBA, Tokyo (JP)

(72) Inventors: Yusuke MORIUCHI, Tokyo (JP); Toshimitsu KANEKO, Kawasaki-shi (JP); Kanako SAITO, Kawasaki-shi (JP)

(73) Assignee: KABUSHIKI KAISHA TOSHIBA, Tokyo (JP)

(21) Appl. No.: 14/193,535

(22) Filed: Feb. 28, 2014

(30) Foreign Application Priority Data
Mar. 13, 2013 (JP) 2013-050920

(51) Int. Cl. H04N 5/235; H04N 5/232

(52) U.S. Cl. CPC H04N 5/2351; H04N 5/23229
USPC 348/222.1

(57) ABSTRACT

An image processing apparatus includes an acquisition module, a computation module and an image generator. The acquisition module acquires a first image including a substance-unapplied region of a subject and a second image including a substance-applied region of a subject. The first and second images are taken by an imager or imagers having the same sensor characteristics. The computation module computes reflection characteristic of the subject based on the first image and computes application amount of the substance applied to the subject based on the second image and the computed reflection characteristic. The image generator generates an image to be displayed based on the second image and the computed application amount.

### CROSS-REFERENCE, TO RELATED APPLICATION(S)

This application is based upon and claims the benefit of priority from Japanese Patent Application No. 2013-050920, filed on Mar. 13, 2013; the entire contents of which are incorporated herein by reference.

### FIELD

Embodiments described herein relate generally to an image processing apparatus and an image processing method.

### BACKGROUND

When, for example, data of a moving image or a still image of a woman taken by a video camera or a digital camera is image-processed to check application unevenness of a sunscreen or a cosmetic applied to her face, the application unevenness can be emphasized if her face was illuminated with ultraviolet light during the imaging.

### BRIEF DESCRIPTION OF THE DRAWINGS

FIG. 1 is a block diagram of an image processing apparatus according to a first embodiment.

FIG. 2 is a flowchart showing how the image processing apparatus according to the first embodiment operates.

FIG. 3 shows an example manner of imaging a substance-unapplied region image and a substance-applied region image individually.

FIG. 4 shows an example manner of imaging a substance-unapplied region image and a substance-applied region image simultaneously.

FIGS. 5A-5C show an input image, a likelihood image, and reference images, respectively.

FIG. 6 is a block diagram of another image processing apparatus according to a first embodiment.

FIG. 7 is a block diagram of an image processing apparatus according to a second embodiment.

FIG. 8 is a flowchart showing how the image processing apparatus according to the second embodiment operates.

FIG. 9 is a block diagram of a hardware configuration according to the first and second embodiments.

### DETAILED DESCRIPTION

According to one embodiment, an image processing apparatus includes an acquisition module, a computation module and an image generator. The acquisition module acquires a first image including a substance-unapplied region of a subject and a second image including a substance-applied region of a subject. The first and second images are taken by an imager or imagers having the same sensor characteristics. The computation module computes reflection characteristic of the subject based on the first image and computes application amount of the substance applied to the subject based on the second image and the computed reflection characteristic. The image generator generates an image to be displayed based on the second image and the computed application amount.

Various embodiments will be described hereinafter with reference to the accompanying drawings. Items common to the embodiments will be given common reference symbols and will not be described redundantly.

### Embodiment 1

FIG. 1 is a block diagram of an image processing apparatus 1 according to a first embodiment. The image processing apparatus 1 is equipped with an imaging unit 11, a processor 12, and a display unit 13. The processor 12 is composed of a mode selector 121, a reference region calculator 122, a characteristics computation module 123, an application amounts computation module 124, and an image generator 125.

The image processing apparatus 1 takes an input image containing an arbitrary subject and displays an image which presents amounts of an arbitrary substance applied to the subject. Example subjects are by a human skin, human hair, a cloth, and paper. Example substance applied are cosmetics to be applied to a skin as typified sunscreen cream, foundation cream, and humectant cream and a dye as typified by a hair dye.

The imaging unit 11 takes an input image according to an imaging mode selected by the mode selector 121, and transmits the input image to the mode selector 121 and the image generator 125. The imaging unit 11 has a sensor camera which uses a CCD (charge-coupled device) image sensor, a CMOS (complementary metal-oxide-semiconductor) image sensor, or the like. Where the filters of the sensor camera are primary color filters as typified by RGB filters, the imaging unit 11 generates signals of an input image by performing inverse γ correction on R, G, and B signals obtained from the sensor camera. Where the filters of the sensor camera are complementary color filters as typified by CMYK filters, the imaging unit 11 generates signals of an input image by performing inverse γ correction on C, M, Y, and K signals obtained from the sensor camera or converting C, M, Y, and K signals into R, G, and B signals by a prescribed conversion method and performing inverse γ correction on the latter.

The input signals are not limited to R, G, and B signals and C, M, Y, and K signals and may be signals of any of other kinds of video signal formats such as Y, U, and V signals. For example, Y, U, and V signals are input to the processor 12, an input image can be acquired by converting them into R, G, and B signals by a prescribed conversion method and performing inverse γ correction on the latter. If the video signal format of the sensor camera is unknown, an input image is produced by performing inverse γ correction on individual input signals.

If the absorption characteristic of a substance applied is known in advance, it is desirable that a bandpass filter that passes light in a wavelength range that conforms to the absorption characteristic of the substance applied be set in the sensor camera of the imaging unit 11. For example, in the case of a substance applied being a sunscreen, it is desirable that an absorption filter that passes ultraviolet light and absorbs visible light be set in the sensor camera.

The mode selector 121 is provided with a characteristics computation mode in which to compute characteristics data and an application amounts computation mode in which to compute application amount data. The mode selector 121 transmits the input image to the reference region calculator 122 while the imaging mode is the characteristics computation mode, and to the application amounts computation module 124 while the imaging mode is the application amounts computation mode.

The reference region calculator 122 calculates reference images from the input image(s) and transmits the calculated reference images to the characteristics computation module 123. The reference images include an image of a substance-unapplied region of the subject and an image of an application region, that is, a substance-applied region of the subject. The substance-unapplied region is a region where the substance is not applied to the subject and the substance-applied region is a region where the substance is applied to the subject.

The characteristics computation module 123 computes characteristics data, that is, reflection characteristic data of the subject and absorption characteristic data of the substance applied, based on the reference images. And, the characteristics computation module 123 transmits the computed characteristic data to the application amounts computation module 124.

The application amounts computation module 124 computes application amount data indicating amounts of a substance applied to a subject based on the input image and the characteristics data, and transmits the computed application amount data to the image generator 125.

The image generator 125 generates a display image for presenting the application amounts to a user based on the input image and the application amount data, and transmits the generated display image to the display unit 13.

The display unit 13 displays the received display image to the user.

Next, how the image processing apparatus 1 operates will be described in detail. FIG. 2 is a flowchart showing how the image processing apparatus 1 operate.

At step S201, the mode selector 121 selects an imaging mode. As mentioned above, an imaging mode is selected from the characteristics computation mode in which to compute reflection characteristics data of a subject and absorption characteristic data of a substance applied to the subject and the application amounts computation mode in which to compute amounts of a substance applied using the thus-computed characteristics data.

The image processing apparatus 1 may either select an imaging mode automatically or cause a user to select it. In the case of the automatic selection, for example, the characteristics computation mode is selected when the image processing apparatus 1 is used for the first time and the application amounts computation mode is selected when it is used for the second time or later. Alternatively, an imaging mode may be selected automatically based on a current time and a time when characteristics data were calculated. In this case, the characteristics computation mode is selected after passage of a prescribed time from computation of characteristics data by the image processing apparatus 1 and the application amounts computation mode is selected before that. The imaging unit 11 is informed of the selected imaging mode.

At step S202, the imaging unit 11 takes an input image(s) according to the imaging mode selected at step S201. In the case of the characteristics computation mode, an image containing a substance-unapplied region of a subject and an image containing a substance-applied region of the subject are taken. A substance-unapplied region image and a substance-applied region image may be taken individually. Alternatively, a single input image may be taken so as to contain such two kinds of regions. FIG. 3 shows an example manner of imaging individual images, and FIG. 4 shows an example manner of imaging an image containing such two kinds of regions,

FIG. 3 shows a situation that the user is going to take input images by directing an imaging apparatus 301 held by his or her right hand to a subject 300. The imaging apparatus 301 corresponds to the image processing apparatus 1 and has the imaging unit 11 (sensor camera) on its back side. At the time of imaging, it is preferable that a frame 303 be displayed on the display screen and an instruction 302 be displayed which instructs the user to register an imaging target with the frame 303. In imaging a substance-unapplied region (e.g., first imaging), a message “Image a skin region placed in the frame” is displayed. In imaging a substance-applied region (e.g., second imaging), a message “Image a sunscreen-applied region placed in the frame” is displayed. It is preferable that the user be able to change the size of the frame 303 by making an instruction through a button 304. In addition to making instructions with display of the flame 303, it is possible to display an explanation of an imaging method, to display symbols or illustrations for assisting the imaging, or to instruct the user through verbal guidance or the like.

Where an input image containing a substance-unapplied region and a substance-applied region is to be taken by one shot in the manner shown in FIG. 4, the user performs imaging according to an instruction 305 so that a substance-unapplied region and a substance-applied region fit in specified regions 306 and 307 individually. Imaging timing may be either determined by the user manually or determined automatically. Where imaging timing is determined automatically, a procedure may be employed that pixel signals of each of the two specified regions 306 and 307 are classified by a prescribed clustering technique and an input image may be acquired with such imaging timing that the two sets of signals corresponding to the two respective regions are discriminated from each other most properly. For example, pixel signals of each region can be classified into an arbitrary number pixel sets using a clustering technique such as the K-NN method, Ward's method, or the K-means method.

In the case of the application amounts computation mode, an image of a region where the user wants to check amounts and application unevenness of what is applied to the subject is taken.

In each of the characteristics computation mode and the application amounts computation mode, the input image(s) taken by the imaging unit 11 is transmitted to the mode selector 121.

At step S203, the destination of the input image is determined according to the imaging mode. In the characteristics computation mode, the input image is transmitted to the reference region calculator 122 from the mode selector 121. In the application amounts computation mode, the input image is transmitted to the application amounts computation module 124 from the mode selector 121.

At step S204, the reference region calculator 122 calculates reference images based on the substance-unapplied region and the substance-applied region contained in the input image(s). The calculated reference images are transmitted to the characteristics computation module 123. The reference images are a substance-unapplied region image which is an image of a region where the amounts of a substance applied to the subject are small and a substance-applied region image which is an image of a region where the amounts of the substance applied to the subject are largest in the substance-applied region.

Example methods for calculating a substance-unapplied region image and a substance-applied region image from the substance-unapplied region and the substance-applied region, respectively, are a method of extracting a central rectangular region from each region through trimming and a method of classifying pixel signals of each region by an existing clustering technique.

In the latter method, pixel signals of each region are classified into an arbitrary number of pixel sets using a clustering technique such as the K-NN method, Ward's method, or the M-means method. Each of a substance-unapplied region image and a substance-applied region image is determined so as to include many pixel signals that are classified as belonging to a pixel set that accounts for a largest percentage of the substance-unapplied region or the substance-applied region among the thus-determined pixel sets.

More specifically, percentages of each of the substance-unapplied region and the substance-applied region the thus-determined pixel sets account for are defined as their likelihoods that they should constitute a substance-unapplied region image or a substance-applied region image. A substance-unapplied region image and a substance-applied region image can be calculated by giving the likelihood of each pixel set to each of the pixels belonging to it and calculating a maximum likelihood region in each of the substance-unapplied region and the substance-applied region. Alternatively, a substance-unapplied region image and a substance-applied region image may be calculated by selecting a region that is centered by an average pixel or a median pixel of a pixel set that is most dominant in each of the substance-unapplied region and the substance-applied region when the pixel signals are classified.

FIGS. 5A-5C illustrate an example of how reference images are calculated by calculating likelihoods from a substance-applied region and a substance-unapplied region contained in an input image. FIGS. 5A-5C are an input image, a likelihood image, and reference images, respectively. The left half and the right half of the input image shown in FIG. 5A are a substance-applied region and a substance-unapplied region, respectively. The likelihood image shown in FIG. 5B is an image indicating the likelihood of each pixel that should belong to a substance-applied region image. The luminance of each pixel represents its likelihood; high-luminance pixels are pixels that have been classified as belonging to a region where a substance would be applied and low-luminance pixels are pixels that have been classified as belonging to a region where a substance would not be applied. It is seen from FIG. 5C that reference images, that is, a substance-applied region image and a substance-unapplied region, are calculated from the substance-applied region and the substance-unapplied region, respectively. As mentioned above, the substance-applied region image is an image of a region where the amounts of a substance applied are largest in the substance-applied region and the substance-unapplied region image is an image of a region where the amounts of the substance applied are small.

At step S205, the characteristics computation module 123 computes characteristics data based on the reference images determined at step S204. The characteristics data consist of reflection characteristic data of the subject and absorption characteristic data of the substance applied. The thus-obtained characteristics data are transmitted to the application amounts computation module 124.

First, the characteristics computation module 123 computes reflection characteristic data based on the substance-unapplied region image. Let the vector of a signal obtained at a pixel position xy of the substance-unapplied region image be expressed as:

Yᵣ₀^{xy}=[Yᵣ₀_{_{R}}^{xy},Yᵣ₀_{_{G}}^{xy},Yᵣ₀_{_{B}}^{xy}]^{t} [Formula 1]

the reflection characteristic data of the subject be represented by a vector O=[O_{R}, O_{G}, O_{B}]^{t}, and the diffuse reflection coefficient at the pixel position xy be represented by α^{xy}. The vector Yᵣ₀^{xy} is given by the following Equation (1):

[Formula 2]

Yᵣ₀_{ᵢ}^{xy}=α^{xy}O₁,(i=R,G,B) (1)

The absolute value of the vector O is equal to 1. It is known that the reflection characteristic data vector O varies with the sensor camera of the imaging unit 11 even if the same subject is taken because it varies depending on the characteristics of the sensor camera.

An optimum reflection characteristic data vector O that satisfies Equation (1) can be obtained by determining a reflection characteristic data vector O that satisfies the following Formula (2):

$$\begin{matrix}[ Formula 3 ] & \\ argmin {\sum }_{xy = 1}^{N} {\sum }_{i = R , G , B} {( {Y}_{r {0}_{i}}^{xy} - {α}^{xy} {O}_{i} )}^{2} & ( 2 )\end{matrix}$$

Formula (2) can be calculated according to a prescribed algorithm of linear programming such as the gradient descent method or Newton's method or by the least squares method. In Equation (2), N is the number of pixels in the substance-unapplied region image.

Then the characteristics computation module 123 computes absorption characteristic data of the substance applied based on the substance-applied region image and the reflection characteristic data of the subject. Let the vector of a signal obtained at a pixel position xy of the substance-applied region image be expressed as:

Yᵣ₁^{xy}=[Yᵣ₁_{_{R}}^{xy},Yᵣ₁_{_{G}}^{xy},Yᵣ₁_{_{B}}^{xy}]^{t} [Formula 4]

the reflection characteristic data of the subject obtained from the substance-unapplied region image be expressed as a vector O=[O_{R}, O_{G}, O_{B}]^{t}, the diffuse reflection coefficient at the pixel position xy be represented by α^{xy}, the absorption characteristic data of the substance applied be represented by a vector A=[A_{R}, A_{G}, A_{B}]^{t}, and the application amount at the pixel position xy be represented by β^{xy}. The vector Yᵣ₁^{xy} is given by the following Equation (3):

[Formula 5]

Yᵣ₁_{ᵢ}^{xy}=α^{xy}O₁×10^{-β}^{^{xy}}^{A}^{₁},(i=R,G,B) (3)

The absolute value of the vector A is equal to 1. It is known that the reflection characteristic data vector A of varies with the sensor camera of the imaging unit 11 even if the same substance applied is taken because it varies depending on the characteristics of the sensor camera.

An optimum absorption characteristic data vector A that satisfies Equation (3) can be obtained by determining an optimum absorption characteristic data vector A that satisfies the following Formula (4) which is a modified version of Equation (3):

$$\begin{matrix}[ Formula 6 ] & \\ log \frac{{O}_{i}}{{Y}_{r {1}_{i}}^{xy}} = {β}^{xy} {A}_{i} - log {α}^{xy} , ( i = R , G , B ) & ( 4 )\end{matrix}$$

An optimum absorption characteristic data vector A that satisfies Equation (4) can be obtained by determining an absorption characteristic data vector A that satisfies the following Formula (5):

$$\begin{matrix}[ Formula 7 ] & \\ argmin {\sum }_{xy = 1}^{N} {\sum }_{i = R , G , B} {( log \frac{{O}_{i}}{{Y}_{r {1}_{i}}} - {β}^{xy} {A}_{i} + log {α}^{xy} )}^{2} & ( 5 )\end{matrix}$$

A vector A that satisfies Formula (5) can be obtained by the same method as the method for calculating an optimum solution of Formula (2).

Characteristics data can be computed from the input image(s) in the above-described manner. The thus-determined characteristics data are held by the characteristics computation module 123 until the characteristics computation mode is selected again.

The above description is directed to the case of determining each of a reflection characteristic data vector O and an absorption characteristic data vector A from all pixel signals of the substance-unapplied region image or the substance-applied region image. Alternatively, a reflection characteristic data vector O and an absorption characteristic data vector A may be determined from an average vector Yᵣₒ^{ave} of the substance-unapplied region image and an average vector Yᵣ₁^{ave} of the substance-applied region image, respectively. In this case, a reflection characteristic data vector O and an absorption characteristic data vector A can be obtained by solving the following Formulae (6) and (7) instead of Formulae (2) and (5), respectively:

$$\begin{matrix}[ Formula 8 ] & \\ argmin {\sum }_{i = R , G , B} {( {Y}_{r {0}_{i}}^{ave} - {α}^{ave} {O}_{i} )}^{2} & ( 6 ) \\ [ Formula 9 ] & \\ argmin {\sum }_{i = R , G , B} {( log \frac{{O}_{i}}{{Y}_{r {1}_{i}}^{ave}} - {β}^{ave} {A}_{i} + log {α}^{ave} )}^{2} & ( 7 )\end{matrix}$$

By adding a storage unit 126 in the characteristics computation module 123 (see FIG. 6), a function may be added which holds, in the storage unit 126, calculated reflection characteristic data of plural patterns corresponding to respective combinations of a user, an illumination type, and an application substance type and uses reflection characteristic data that is suitable for a use by reading it from the storage unit 126.

Arbitrary initial values are set for characteristics data in advance. If the application amounts computation mode is selected in a state that the characteristics computation mode has not been selected even once, the characteristics computation module 123 transmits the preset characteristics data to the application amounts computation module 124.

A maximum value β_{MAX} or an average value PAVE of application amounts β^{xy} may be determined in computing an absorption characteristic data vector A. In this case, the thus-determined maximum value β_{MAX} or average value β_{AVE} is transmitted to the image generator 125 and used as a threshold value for amounts of the substance applied.

Steps S206-S208 are steps that are executed on an input image when the application amounts computation mode is selected as an imaging mode. At step S206, application amount data are computed by the application amounts computation module 124 based on an input image taken at step S202 and the characteristics data determined at step S205. The application amount data are data representing amounts of a substance applied at respective pixel positions of a subject contained in an input image. The thus-determined application amount data are transmitted to the image generator 125.

The vector of a signal obtained at a pixel position xy of an input image

Yᵢₙ^{xy}=[Yᵢₙ_{_{R}}^{xy},Yᵢₙ_{_{G}}^{xy},Yᵢₙ_{_{B}}^{xy}]^{t} [Formula 10]

can be expressed as the following Equation (8) using the reflection characteristic data vector O=[O_{R}, O_{G}, O_{B}]^{t} and the absorption characteristic data vector A=[A_{R}, A_{G}, A_{B}]^{t} that were determined at step S205, and the diffuse reflection coefficient α^{xy} and the application amount β^{xy} at the pixel position xy:

[Formula 11]

Yᵢₙ_{ᵢ}^{xy}=α^{xy}O₁×10^{-β}^{^{xy}}^{A}^{₁},(i=R,G,B) (8)

An application amount at each pixel position of the input image can be determined by determining optimum α^{xy} and β^{xy} values that satisfy Equation (8). Optimum α^{xy} and β^{xy} values that satisfy Equation (8) can be determined by determining optimum α^{xy} and β^{xy} values that satisfy the following Equation (9) which is a modified version of Equation (8):

$$\begin{matrix}[ Formula 12 ] & \\ log \frac{{O}_{i}}{{Y}_{{in}_{i}}^{xy}} = {β}^{xy} {A}_{i} - log {α}^{xy} , ( i = R , G , B ) & ( 9 )\end{matrix}$$

Optimum α^{xy} and values that satisfy Equation (9) can be obtained by calculating an optimum solution of the following Formula (10):

$$\begin{matrix}[ Formula 13 ] & \\ argmin {\sum }_{i = R , G , B} {( log \frac{{O}_{i}}{{Y}_{{in}_{i}}^{xy}} - {β}^{xy} {A}_{i} + log {α}^{xy} )}^{2} & ( 10 )\end{matrix}$$

An optimum solution of Formula (10) can be calculated by the same method as used at step S205.

With the above-described processing, the vector Yᵢₙ^{xy} of each pixel signal of the input image can be separated into the reflection characteristic data vector O of the subject, the diffuse reflection vector α^{xy}, the absorption characteristic data vector A of the substance applied, and the application amount β^{xy}. As a result, the amount β^{xy} of the substance applied can be calculated irrespective of the reflection characteristic data vector O and the absorption characteristic data vector A of the substance applied which are affected by the sensor characteristics and the diffuse reflection vector α^{xy} which is affected by an illumination shadow variation. Application amount data can be obtained by performing the above-described processing on all the pixels of the input image.

The separation between the diffuse reflection vector α^{xy} and the amount β^{xy} of the substance applied exhibits high performance if the substance-unapplied region image and the substance-applied region image are acquired from the same input image or even if they are acquired from different input images as long as the input images are taken in illumination environments having no large differences.

At step S207, a display image is generated based on the input image that was taken at step S202 and the application amount data that were determined at step S206. The generated display image is transmitted to the display unit 13 and the application amounts are presented to the user.

The application amount data are a density image representing the application amounts at the respective pixel positions of the input image. Example methods for generating a display image are a method directly using the application amount data and a method of superimposing the application amount data on the input image. For another example, an application-amounts-emphasized image obtained by performing such image processing as lightness conversion, contrast conversion, histogram correction, tone curve correction, or threshold processing on a generated display image may be used as a display image. A threshold value used for the threshold processing may be a preset value or a value obtained as a result of a manual change by the user.

Where a maximum value β_{MAX} or an average value β_{AVE} of application amounts is calculated from the reference images, the application amounts may be presented to the user in such a manner that image regions where the application amounts of respective pixel positions are smaller than a threshold value that is calculated using β_{MAX} or β_{AVE} are emphasized.

For a further example, a light and shade image that conforms to a score, a color image, or a score may be generated using an average score of the application amount data of the entire input image or an arbitrary region and used as a display image.

At step S208, the display image generated at step S107 is displayed by the display unit 13. The display unit 13 is a liquid crystal display, an organic EL (electroluminescence) display, or the like.

In the above-described image processing apparatus and method according to the first embodiment, first, a first image(s) is acquired and characteristics data including reflection characteristic data of a subject is calculated using the first image. Both of reflection characteristic data of the subject and absorption characteristic data of a substance applied may be acquired from a single first image. Alternatively, it is possible to acquire reflection characteristic data of the subject from one image and acquire absorption characteristic data of the substance applied from another image. Application amounts are calculated for a second image taken by an imaging apparatus having the same sensor camera characteristics as an imaging apparatus that took the first image, using the characteristics data calculated from the first image. Taking the first image and the second image by the imaging apparatus having the same sensor camera characteristics includes taking the first image and the second image by the single imaging apparatus.

Where application amounts are calculated by emphasizing application unevenness of a substance applied using a special illumination device for, for example, ultraviolet illumination and acquiring a resulting image as in the prior art, no consideration is given to the characteristics of a camera for acquiring an image and it is difficult to discriminate between a shadow and application unevenness.

In contrast, in the embodiment, application amounts of a sunscreen applied to a user skin can be checked without being affected by the characteristics of a camera. Furthermore, application amount data are not affected by a shadow because a signal variation corresponding to application of a sunscreen and a signal variation due to an illumination shadow can be separated from a signal variation of an input image. This allows the user to quickly recognize application unevenness of a sunscreen without being affected by a signal variation due to a shadow. Furthermore, it is not necessary to use special illumination device for, for example, ultraviolet illumination.

### Embodiment 2

The second embodiment is different from the first embodiment in the kinds of imaging modes. That is, this embodiment uses three imaging modes, that is, a reflection characteristic computation mode in which to compute reflection characteristic data of a subject, an absorption characteristic computation mode in which to compute application amount data after computing absorption characteristic data of a substance applied (a single image is used), and an application amounts computation mode.

In the image processing apparatus according to the second embodiment, first, a first image is acquired and reflection characteristic data of a subject is computed in the reflection characteristic computation mode. Then a second image is acquired that is taken by an imaging apparatus having the same sensor camera characteristics as one that took the first image. The image processing apparatus computes absorption characteristic data of a substance applied based on the second image and computes amounts of the substance applied based on the second image that has been used for computing the absorption characteristic data. In the application amounts computation mode which is established when a third image has been taken by an imaging apparatus having the same sensor camera characteristics as the ones that took the first image and the second image, the image processing apparatus computes amounts of a substance applied using the absorption characteristic computation mode that was calculated based on the second image.

For example, which of the absorption characteristic computation mode and the application amounts computation mode should be selected to compute application amounts of a substance applied can be judged using the difference between a time of taking of a first image and a time of computation of application amounts. The application amounts computation mode is selected if the difference between a time of taking of a first image and a time of computation of application amounts is within a prescribed time, and the absorption characteristic computation mode is selected if the difference is longer than the prescribed time. For example, when a moving image is taken, it is possible to select the absorption characteristic computation mode for a prescribed number of frames starting from the first frame and to select the application amounts computation mode for the subsequent frames. If absorption characteristics are computed based on plural second images in the absorption characteristic computation mode, their average may be used as an absorption characteristic in the application amounts computation mode.

FIG. 7 is a block diagram of the image processing apparatus 6 according to the second embodiment. The image processing apparatus 6 is different from the image processing apparatus 1 in the details of pieces of processing performed in an imaging unit 61 and a mode selector 621, a reference region calculator 622 of a processor 62. The image processing apparatus 6 takes an input image containing an arbitrary subject and displays a display image which presents amounts of an arbitrary substance applied to the subject.

The imaging unit 61 takes an input image according to an imaging mode selected by the mode selector 621, and transmits the input image taken to the mode selector 621 and the image generator 125.

The mode selector 621 is provided with the three imaging modes, that is, the reflection characteristic computation mode in which to compute reflection characteristic data, the absorption characteristic computation mode in which to compute application amount data after computing absorption characteristic data, and the application amounts computation mode, and transmits the input image according to the imaging mode. In the reflection characteristic computation mode, the mode selector 621 transmits the input image to the reference region calculator 622. In the absorption characteristic computation mode, the mode selector 621 transmits the input image to the reference region calculator 622 and the application amounts computation module 124. In the application amounts computation mode, the mode selector 621 transmits the input image to the application amounts computation module 124.

The reference region calculator 622 calculates a reference image from the input image and transmits the calculated reference image to the characteristics computation module 123. The reference image is an image of a substance-unapplied region of a subject or an image of an application region, that is, a substance-applied region of the subject. The calculated reference image is transmitted to the characteristics computation module 123.

Next, how the image processing apparatus 6 operates will by described in detail. FIG. 8 is a flowchart showing how the image processing apparatus 6 operates. Steps S206-S208 will not be described because they are the same as described above with reference to FIG. 2.

At step S701, the mode selector 621 selects an imaging mode. As mentioned above, an imaging mode is selected from the reflection characteristic computation mode in which to compute reflection characteristic data of a subject, the absorption characteristic computation mode in which to compute application amount data after computing absorption characteristic, data of a substance applied, and the application amounts computation mode in which to compute amounts of a substance applied to a subject. The image processing apparatus 6 may cause a user to select an imaging mode. Alternatively, the image processing apparatus 6 may select the reflection characteristic computation mode when the image processing apparatus 6 is used for the first time, and cause the user to select the absorption characteristic computation mode or the application amounts computation mode when it is used for the second time or later. The imaging unit 61 is informed of the selected imaging mode.

At step S702, the imaging unit 61 takes an input image according to the imaging mode selected at step S701, in the case of the reflection characteristic computation mode, an image containing a substance-unapplied region of a subject is taken. At the time of imaging, as in the first embodiment, it is desirable to display a prescribed frame on the display screen and gives the user an instruction for causing the user to take an input image so that a substance-unapplied region is included in a specified region of the input image. In, the modes other than the reflection characteristic computation mode, an image of a region where the user wants to check amounts and application unevenness of a substance applied is taken. The input image thus taken is transmitted to the mode selector 621.

At steps S703 and S704, the mode selector 621 selects the destination of the input image according to the imaging mode. At step S703, if the imaging mode is the reflection characteristic computation mode, the mode selector 621 transmits the input image to the reference region calculator 622. If the imaging mode is one of the other two modes, the process moves to step S704.

At step S704, if the imaging mode is the absorption characteristic computation mode, the mode selector 621 transmits the input image to the reference region calculator 622 and the application amounts computation module 124

At step S705, the reference region calculator 622 calculates a substance-unapplied region image from a substance-unapplied region contained in the input image by the same method as used at step S204 (see FIG. 2)

At step S706, the characteristics computation module 123 computes reflection characteristic data of the subject based on the substance-unapplied region image calculated at step S705 by the same method as used at step S205 (see FIG. 2), and transmits the computed reflection characteristic data to the application amounts computation module 124.

At step S707, the reference region calculator 622 calculates a substance-applied region image from the input image and transmits it to the characteristics computation module 123. A substance-applied region image may be calculated by a method in which pixel signals of the input image are classified by an existing clustering technique. In this method, a substance-applied region image is determined so as to include many pixel signals that are classified as belonging to a pixel set that accounts for a largest percentage of the input image among the thus-determined pixel sets. More specifically, percentages of the input image the thus-determined pixel sets account for are defined as their likelihoods that they should constitute a substance-applied region image. A substance-applied region image can be calculated by giving the likelihood of each pixel set to each of the pixels belonging to it and calculating a maximum likelihood region.

Alternatively, a substance-applied region image may be calculated by clustering a combination of the pixel signals of the input image and the pixel signals of the substance-unapplied region image calculated at step S705. In this case, likelihoods that pixel sets should constitute a substance-applied region image may be calculated so that likelihoods of pixels classified as belonging to the same pixel set as pixels of the substance-unapplied region image are reduced.

At step S708, the characteristics computation module 123 computes absorption characteristic data of the substance applied using the substance-applied region image calculated at step S707 and the reflection characteristic data computed at step S706, in the same manner as at step S205 (see FIG. 2). The computed absorption characteristic data are transmitted to the application amounts computation module 124.

Arbitrary initial values are set for characteristics data in advance. If another mode is selected in a state that the reflection characteristic computation mode has not been selected even once, the characteristics computation module 123 transmits the preset reflection characteristic data to the application amounts computation module 124. If the application amounts computation mode is selected without prior selection of the absorption characteristic computation mode, the characteristics computation module 123 transmits preset absorption characteristic data to the application amounts computation module 124.

The image processing apparatus 6 according to the second embodiment provides not only the same advantages as the first embodiment but also an advantage that amounts and application unevenness of a substance applied to a subject can be presented to a user without the need for taking an image of a substance-applied region in advance.

For example, the image processing apparatus according to each embodiment can be implemented using a general-purpose computer as basic hardware. Programs to be run may have a module configuration including the above-described functions. The programs may be provided either being stored in a ROM or the like in advance or being recorded in a computer-readable recording medium such as a CD-ROM, a CD-R, a DVD, or the like as files that are in installable or executable form.

Although each of the embodiments is provided with the imaging unit and the display unit, modes are conceivable that are provided with neither of them. For example, an image to be used for computing reflection characteristic data and an image to be used for computing application amount data may be acquired from wire-connected or wirelessly connected imaging apparatus as long as they have the same sensor camera characteristics. An image to be used for computing reflection characteristic data and an image to be used for computing application amount data may be acquired from an external storage device. An image generated by the image generator may be sent to an external display device and displayed thereon.

Although the two embodiments of the invention have been described above, they are just examples and should not be construed as restricting the scope of the invention. Each of these novel embodiments may be practiced in various other forms, and part of it may be omitted, replaced by other elements, or changed in various manners without departing from the spirit and scope of the invention. These modifications are also included in the invention as claimed and its equivalents. Further, a part of the configurations shown in the above embodiments may be included in a cloud system through networks.

AU portions or a portion of respective functions according to the above embodiments may be implemented by hardware such as a processor or the like. For example, a hardware configuration may include a processor 901, a memory 902, a display 903 and an operation module 904 or the like, as shown in FIG. 9. The memory 902 may contain a program that causes the processor 901 to execute the above embodiments. Also, alteration, deletion, addition, and the like, of the steps as described in the above embodiments are possible.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising:
an acquisition module that acquires a first image including a substance-unapplied region of a subject and a second image including a substance-applied region of a subject,
wherein the first and second images are taken by an imager or imagers having the same sensor characteristics;
a computation module that computes reflection characteristic of the subject based on the first image and that computes application amount of the substance applied to the subject based on the second image and the computed reflection characteristic; and
an image generator that generates an image to be displayed based on the second image and the computed application amount.

2. The apparatus of claim 1,
wherein the computation module computes the application amount according to a kind of the substance.

3. The apparatus of claim 1, further comprising:
a reference region calculator that specifies the substance-unapplied region in the first image,
wherein the computation module computes the reflection characteristic of the subject based on the substance-unapplied region.

4. The apparatus of claim 3,
wherein the reference region calculator further specifies the substance-applied region in the first image, and
the computation module computes the absorption characteristic of the substance based on the substance-applied region and the computed reflection characteristic of the subject.

5. The apparatus of claim 1, further comprising:
a reference region calculator that specifies a substance-applied region of the subject from the second image,
wherein the computation module computes the absorption characteristic of the substance based on the substance-applied region and the computed reflection characteristic of the subject.

6. The apparatus of claim 1,
wherein the acquisition module further acquires a third image taken by an imaging apparatus having the same sensor characteristics as the imaging apparatuses by which the first and second images are taken, and
the computation module computes the absorption characteristic of the substance based on the third image and the computed reflection characteristic of the subject.

7. The apparatus of claim 1, further comprising:
an imaging unit that has a filter for absorbing light in a predetermined wavelength range,
wherein the acquisition module acquires the first and second images from the imaging unit.

8. The apparatus of claim 7,
wherein the filter of the imaging unit has the same spectral characteristic when the first image is acquired and when the second image is acquired.

9. The apparatus of claim 1, further comprising:
a guiding module that guides a manner of taking an image of the subject so that a substance-unapplied region or a substance-applied region is included in a specified region of the first image or a specified region of the second image when the first or second image is taken.

10. The apparatus of claim 4, further comprising:
a guiding module that guides a manner of taking an image of the subject so that the substance-unapplied region is included in a first specified region of the first image and so that the substance-applied region is included in a second specified region of the first image, respectively,
wherein the reference region calculator calculates a substance-unapplied region and a substance-applied region based on classification results of pixel signals in the first and second specified regions.

11. The apparatus of claim 4,
wherein the reference region calculator (i) calculates pixel sets by clustering pixel signals in the first image, (ii) adds a likelihood to each pixel of the first image, the likelihood being calculated based on a proportion of the calculated pixel sets to the first image and (iii) calculates a maximum likelihood region as the substance-unapplied region or the substance-applied region.

12. The apparatus of claim 1,
wherein the reflection characteristic is matrix data indicating a reflection characteristic of the subject, and
elements of the matrix data are calculated based on wavelength signals of pixel signals of the first image.

13. The apparatus of claim 4,
wherein the absorption characteristic is matrix data indicating an absorption characteristic of the substance, and
elements of the matrix data are calculated by decomposing signal ratios between the reflection characteristic and wavelength signals of pixel signals of the substance-applied region.

14. The apparatus of claim 1, further comprising:
a storage module that stores a plurality of pattern of reflection characteristic according to respective uses including a user, an illumination type and a kind of substance to be applied, as factors.

15. The apparatus of claim 1,
wherein the substance includes cosmetics or a dye.

16. The apparatus of claim 1,
wherein the subject includes a skin and the substance is applied to the skin.

17. An image processing method comprising the steps of:
acquiring a first image including a substance-unapplied region of a subject and a second image including a substance-applied region of a subject,
wherein the first and second images are taken by an imager or imagers having the same sensor characteristics;
computing reflection characteristic of the subject based on the first image;
computing application amount of the substance applied to the subject based on the second image and the computed reflection characteristic; and
generating an image to be displayed based on the second image and the computed application amount.

18. The image processing apparatus comprising:
a processor; and
a memory containing a program that causes the processor to execute image processing, the image processing comprising:
acquiring a first image including a substance-unapplied region of a subject and a second image including a substance-applied region of a subject,
wherein the first and second images are taken by an imager or imagers having the same sensor characteristics;
computing reflection characteristic of the subject based on the first image;
computing application amount of the substance applied to the subject based on the second image and the computed reflection characteristic; and
generating an image to be displayed based on the second image and the computed application amount.
